(19) United States
(12) Patent Application Publication
(10) Pub. No.: US 2017/0125175 A1
(43) Pub. Date: May 4, 2017

(54) HIGH-VOLTAGE AND HIGH-POWER SUPERCAPACITOR HAVING MAXIMUM OPERATING VOLTAGE OF 3.2 V

(71) Applicant: KOREA INSTITUTE OF ENERGY RESEARCH, Daejeon (KR)

(72) Inventors: Jong-Huy KIM, Daejeon (KR); Jung-joon YOO, Daejeon (KR); Yong-il KIM, Daejeon (KR)

(73) Assignee: KOREA INSTITUTE OF ENERGY RESEARCH, Daejeon (KR)

(21) Appl. No.: 15/291,240

(22) Filed: Oct. 12, 2016

(30) Foreign Application Priority Data
Oct. 30, 2015 (KR) 10-2015-0152485
Apr. 25, 2016 (KR) 10-2016-0050385

(51) Int. Cl. H01G 11/34; H01G 11/62; H01G 11/70; H01G 11/78; H01G 11/68; H01G 11/52; H01G 11/86

(52) U.S. Cl. CPC H01G 11/34; H01G 11/52; H01G 11/62; H01G 11/86; H01G 11/78; H01G 11/68; H01G 11/70

(57) ABSTRACT

Disclosed is a process of treating activated carbon using carbon dioxide activation, and a supercapacitor that is manufactured using activated carbon, which is treated with carbon dioxide, as an electrode material to thus be stably operable at a high voltage. The supercapacitor according to the present invention includes improved materials of an electrode and an electrolyte constituting the supercapacitor and has optimized electrode properties so as to be stably operable even at a high voltage.

### CROSS-REFERENCE TO RELATED APPLICATION

This application claims the priority benefit of Korean Patent Application No. 10-2015-0152485, filed on Oct. 30, 2015 and Korean Patent Application No. 10-2016-0050385, filed on Apr. 25, 2016 in the Korean Intellectual Property Office, the disclosure of which is incorporated herein by reference.

### BACKGROUND OF THE INVENTION

1. Field of the Invention

The present invention relates to a supercapacitor that is stably operable at a high voltage (for example, an operating voltage of 3 V and a maximum voltage of 3.2 V).

2. Description of the Related Art

A supercapacitor, which is a next-generation energy storage device, has a fast charging and discharging rate, high stability, and an environmentally-friendly characteristic, and is thus receiving attention as a next-generation energy storage device. A typical supercapacitor includes a porous electrode, a current collector, a separator, and an electrolyte. The supercapacitor is driven based on an electrochemical reaction mechanism, whereby voltage is applied to the porous electrodes to selectively adsorb ions, present in an electrolyte solution composition, onto the porous electrodes. Representative examples of current supercapacitors include an electric double-layer capacitor (EDLC), a pseudo-capacitor, and a hybrid capacitor. The electric double-layer capacitor is a supercapacitor which includes an electrode including activated carbon and is based on the reaction mechanism of electric double-layer charging. The pseudo-capacitor is a supercapacitor which includes transition metal oxides or conductive polymers as an electrode and is based on a reaction mechanism of pseudo-capacitance. In addition, the hybrid capacitor has an intermediate characteristic between the EDLC and the electrolytic capacitor.

Recently, core material technologies for capacitor parts, which are suitable for a high voltage, such as electrode materials, electrolytes, and sealants, have been actively developed in order to manufacture a supercapacitor which is stably operable at a high to voltage an operating voltage of 3 V and a maximum voltage of 3.2 V). This is because an electrolyte solution is decomposed or the functional group of an electrode material s decomposed when known materials are used, and accordingly, it is impossible to stably operate the supercapacitor at a high voltage due to the limits of materials and physical properties.

The functional group of the electrode material may be decomposed, thereby generating gases, during operation at a high voltage. The surface of the electrode is exfoliated due to the generated gases, thus reducing the reliability and longevity of the capacitor and causing problems during operation at a high voltage.

An electrolyte material having a large potential window is used in order to ensure an electrolyte able to withstand a high voltage. Further, efforts to control the quantity of fine moisture in the electrolyte solution and to reduce decomposition of the electrolyte have been continuously made by selecting and adding an additive that increases the size of the potential window.

### SUMMARY OF THE INVENTION

Accordingly, the present invention has been made keeping in mind the above problems occurring in the related art, and an object of the present invention is to provide a supercapacitor that includes activated carbon, the specific surface area and pore distribution of which are increased by performing carbon dioxide treatment and controlling physical properties, and an electrolyte, which has a low freezing temperature and a high conductive property, and that has an optimized weight ratio of the electrodes so as to be stably operable at a high voltage.

In order to accomplish the above object, the present invention provides a high-voltage and high-power supercapacitor having a maximum operating voltage of 3.2 V. The supercapacitor includes a storage case, a cathode, an anode disposed to face the cathode, a separation layer positioned between the cathode and the anode, and an electrolyte solution filling the storage case. The cathode and the anode include activated carbon treated with carbon dioxide.

The treatment of the activated carbon using carbon dioxide may include heating the activated carbon in a carbon dioxide atmosphere at 500 to 1200° C.

Further, the activated carbon may be pulverized using a ball mill before being treated with carbon dioxide.

In the supercapacitor according to the present invention, the weight ratio of the anode to the cathode may be 1.16 to 1.30.

In the supercapacitor according to the present invention, the cathode and the anode may be manufactured using a slot die process.

In the supercapacitor according to the present invention, the storage case may be cylindrical.

The electrolyte may include acetonitrile.

Further, the electrolyte may further include a tetrafluoroborate-based ion salt and more specifically spiro-(1,1′)-bipyrrolidium tetrafluoroborate (SBPBF4).

The supercapacitor according to the present invention includes improved materials of an electrode and an electrolyte constituting the supercapacitor and has an optimized electrode property so as to be stably operable even under a high voltage condition.

### BRIEF DESCRIPTION OF THE DRAWINGS

The above and other objects, features and advantages of the present invention will be more clearly understood from the following detailed description taken in to conjunction with the accompanying drawings, in which:

FIGS. 1A, 1B, 1C and 1D are graphs showing the specific surface area and pore distribution of activated carbon treated with carbon dioxide according to Examples of the present invention;

FIG. 2 is a graph showing the particle size distribution of the activated carbon treated with carbon dioxide according to the Examples of the present invention;

FIG. 3 shows the SEM image of the particles of the activated carbon treated with carbon dioxide according to the Examples of the present invention;

FIG. 4 is a graph showing the specific capacitance of electrodes, which are manufactured using the activated carbon treated with carbon dioxide according to the Examples of the present invention;

FIG. 5 is a graph showing the specific capacitance of the electrodes, which are manufactured using the activated carbon treated with carbon dioxide according to the Examples of the present invention, as a function of the scan rate;

FIG. 6 shows a Nyquist diagram of the electrodes, which are manufactured using the activated carbon treated with carbon dioxide according to the Examples of the present invention;

FIGS. 74, 7B, 7C, 7D and 7E are comparative cyclic voltammetry graphs depending on a type of electrolyte solvent;

FIGS. 8A, 8B, 8C and 8D are comparative cyclic voltammetry graphs depending on a type of ion salt;

FIG. 9 is a graph showing the specific capacitance of the electrode as a function of the voltage, depending on the weight ratio of the electrode;

FIG. 10 is a graph showing the specific capacitance of the electrode as a function of the scan rate, depending on the weight ratio of the electrode;

FIG. 11 shows the result of cyclic voltammetry measurement depending on the to weight ratio of the electrode;

FIG. 12 shows a Nyquist diagram depending on the weight ratio of the electrode;

FIG. 13 shows the result of measurement of cycle life, which is represented by a change in the specific capacitance of the supercapacitor according to the present invention as a function of the number of cycles;

FIG. 14 is a graph showing the specific electrostatic capacitance of the supercapacitor according to the present invention;

FIG. 15 shows the cyclic voltammetry pattern property of the supercapacitor according to the present invention as a function of an increase in voltage;

FIG. 16 shows a change in the discharge capacitance of the supercapacitor according to the present invention as a function of the discharge current;

FIG. 17 is a graph showing an IR drop of the supercapacitor according to the present invention as a function of the discharge current;

FIG. 18 is a graph showing constant current charging and discharging properties of the supercapacitor according to the present invention; and

FIG. 19 is a graph showing the discharging property of the supercapacitor according to the present invention, depending on the current.

### DESCRIPTION OF THE PREFERRED EMBODIMENTS

The present invention relates to a supercapacitor that includes an electrode, which includes activated carbon treated with carbon dioxide, and an electrolyte, which includes acetonitrile, and that has a weight ratio of an anode to a cathode in the range of 1.16 to 1.30 so as to be stably operable at a high voltage.

The supercapacitor of the present invention includes the activated carbon, which is treated with carbon dioxide, as the material of the electrode in order to prevent the to occurrence of problems attributable to gases, which are generated due to decomposition of the functional group of the activated carbon during operation at a high voltage. The process of treating the activated carbon according to the present invention includes heating the activated carbon in a carbon dioxide atmosphere at 500 to 1,200° C.

The activated carbon is put in a heating furnace and heated in the carbon dioxide atmosphere. The flow rate at which the carbon dioxide is injected into the heating furnace may depend on the size of the heating furnace or the amount of activated carbon. For a typical laboratory-scale heating furnace, it is preferable to add carbon dioxide at a flow rate of about 10 to 500 cc/min.

It is preferable that the heating temperature of the activated carbon be 500 to 1,200° C. in the carbon dioxide atmosphere. When the temperature is lower than 500° C., activation and surface modification effects of the activated carbon are insignificant, and when the temperature is higher than 1200° C., heat-treating costs may be increased and the activated carbon may degrade.

The activated carbon used in the present invention may be pulverized using a pulverization process, such as ball milling, before being treated with carbon dioxide. Various pulverization processes other than ball milling may be applied, but ball milling is most preferable in that the activated carbon is capable of being mass-produced in a homogeneous form.

During the process of treating the activated carbon according to the present invention, ball milling may be performed at 50 to 3000 rpm for 6 to 100 hrs to perform pulverization, which is a process for controlling the physical properties of the activated carbon, such as the specific surface area and pore distribution.

The functional group of the activated carbon is removed during the process of treating the activated carbon using carbon dioxide, and accordingly, gas may be prevented from being generated during operation at a high voltage, and both capacitance to and resistance properties may be improved. Therefore, the activated carbon treated with carbon dioxide may be used as the material of the electrode, thereby embodying a supercapacitor that is stably operable at a high voltage and has high power.

The supercapacitor according to the present invention includes a storage case, a cathode, an anode disposed to face the cathode, a separator positioned between the cathode and the anode, and an electrolyte solution filling the storage case. The cathode and the anode include activated carbon treated with carbon dioxide, and the weight ratio of the anode to the cathode is 1.16 to 1.30.

When the weight of the anode is less than 1.16 times the weight of the cathode or more than 1.30 times the weight of the cathode, the specific capacitance or the potential window may be reduced due to an increase in voltage or scan rate, thereby reducing the resistance property.

The supercapacitor according to the present invention may include the anode having a thickness of 70 to 90 μm and the cathode having a thickness of 50 to 70 μm. A thinner electrode may be embodied than in the case of a known electrode, thereby ensuring high power of the supercapacitor.

A doctor blade process is mainly used to manufacture the electrode using the activated carbon in the related art. However, in the present invention, it is preferable to produce the electrode using a slot die process.

When the slat die process is applied, the electrode is produced in a roll-to-roll mode, and accordingly, the electrode is capable of being mass-produced and continuously produced. Further, since slurry is applied in a constant amount, stability and reproducibility of the electrode coating layer are excellent. The uniformity of the electrode coating layer (thickness) is very important in order to manufacture a high-voltage/high-power cell such as the supercapacitor according to the present invention. When the known doctor blade process is applied, there is a limit in ensuring the to uniformity of the thickness of the electrode layer and, moreover, it is difficult to form a uniform coating layer at a thickness of 80 or less.

Further, it is preferable that a material having a large potential window, such as acetonitrile, be used as an electrolyte solvent in order to stably operate the supercapacitor according to the present invention at a high voltage (3 to 3.2 V).

Further, the electrolyte of the supercapacitor according to the present invention may include a tetrafluoroborate-based ion salt Particularly, it is preferable that spiro-(1,1)-bipyrrolidium tetrafluoroborate (SBPBF4) be used as the ion salt and that it be mixed with the electrolyte. It is preferable that the concentration of the ion salt added to the electrolyte solution be in the range of 0.1 M to 3.0 M.

The present invention will be described in greater detail with reference to the following Examples. The following description is provided so that this invention will be thorough and complete, and will fully convey the spirit of the invention to those skilled in the art, but the scope of the invention is not limited to the following description. It should be understood that the scope of the present invention is set forth in the claims and all variations are included within the scope of the claims.

### EXAMPLE 1

Treatment of the Activated Carbon Using Carbon Dioxide

YP-50F (Kuraray Co., Ltd., Japan), which was activated carbon commercially used to manufacture the capacitor electrode, was selected as activated carbon, which was a carbon dioxide treatment target. The activated carbon was put in the heating furnace and then heated in a carbon dioxide atmosphere at 900° C. for 1 hr to activate it. The flow rate of carbon dioxide was 40 cc/min.

### EXAMPLE 2

The activated carbon of YP-50F (Kuraray Co., Ltd., Japan) was added to the ball mill and then pulverized at 150 rpm for 24 hrs. The pulverized activated carbon was put in the heating furnace and then heated in a carbon dioxide atmosphere at 900° C. for 1 hr to activate it. The flow rate of carbon dioxide was 40 cc/min.

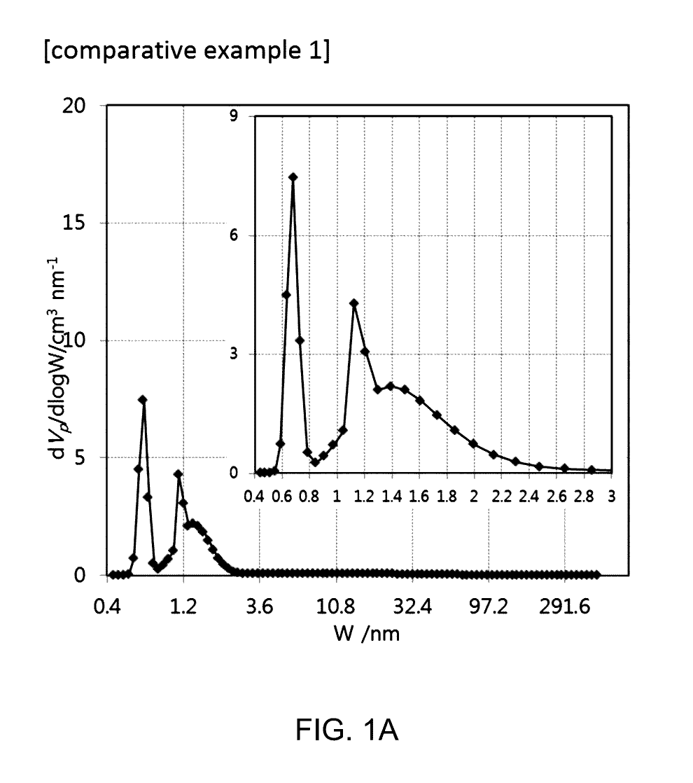

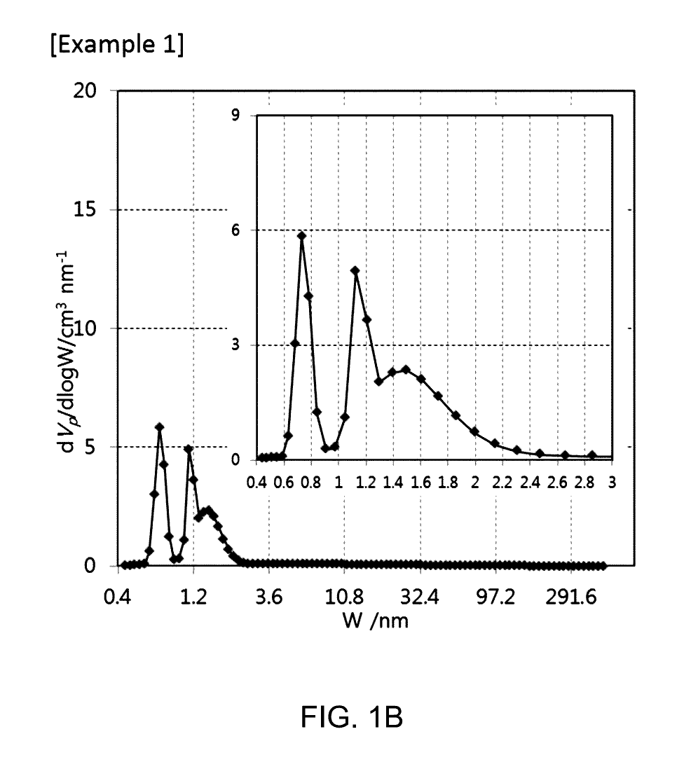

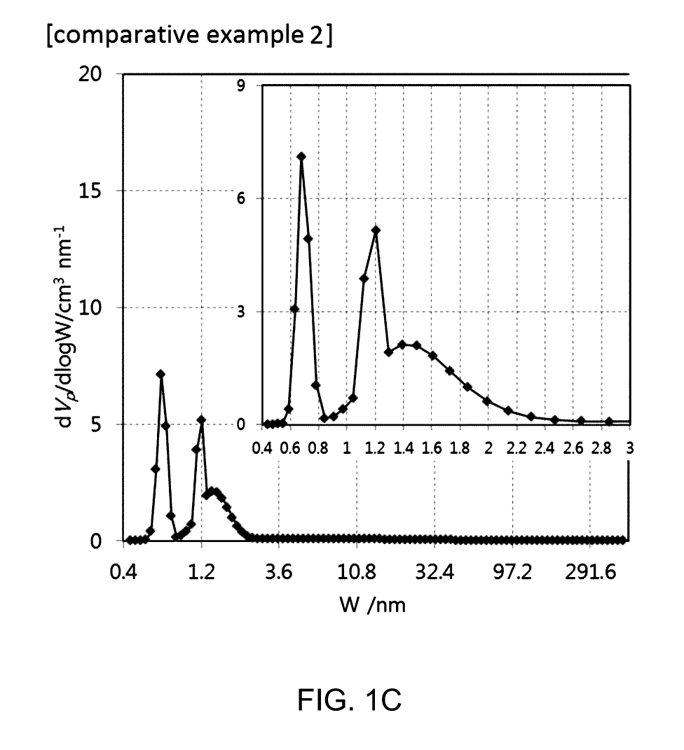

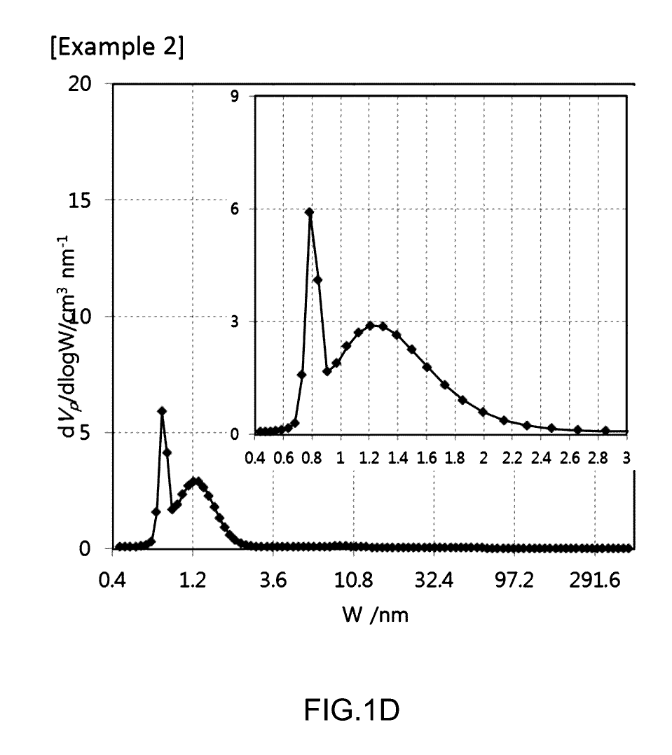

The specific surface area and pore distribution of the activated carbon treated with carbon dioxide in Example 1 (Example 1), the activated carbon treated with carbon dioxide after ball mill treatment (Example 2), the untreated activated carbon (Comparative Example 1), and the activated carbon which was subjected to only ball mill treatment (Comparative Example 2) were confirmed, and are shown in the following Table 1 and FIG. 1.

TABLE 1

| | Comparative | Comparative | | |
|---|---|---|---|---|
| BET plot | Example 1 | Example 2 | Example 1 | Example 2 |
| Vm [cm³(sTP)g⁻¹] | 420.24 | 427.95 | 434.95 | 419.21 |
| a2, BET [m²g⁻¹] | 1829.1 | 1862.6 | 1893.1 | 1824.6 |
| Total pore volume | 0.8583 | 0.8495 | 0.8661 | 0.84 |
| [cm³g⁻¹] | | | | |
| (p/p₀ = 0.990) | | | | |
| Average pore | 1.8769 | 1.8243 | 1.83 | 1.8415 |
| diameter [nm] | | | | |

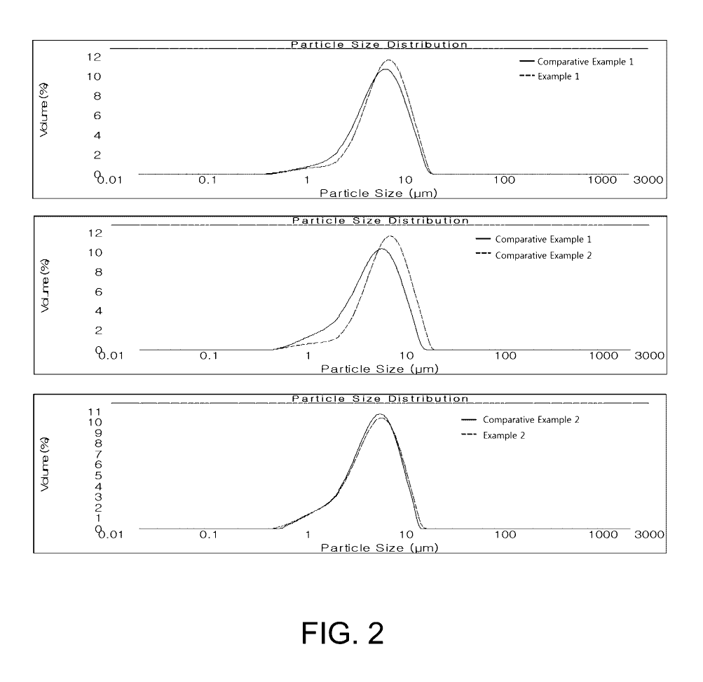

The particle size distribution of activated carbon treated with carbon dioxide in the Examples (Examples 1 and 2) was compared to that of Comparative Examples 1 and 2, and the result is shown in Table 2 and FIG. 2. The specific surface area and pore distribution of the activated carbon, which was treated with carbon dioxide in Example 1 of the present invention, were slightly increased compared to those of known untreated activated carbon (Comparative Example 1). Further, since the particle size is reduced due to carbon dioxide treatment, advantageously, a tap density is increased when the electrode is manufactured.

TABLE 2

| Activated carbon | d(0.1) | d(0.5) | d(0.9) |
|---|---|---|---|
| Comparative Example 1 | 2.908 | 6.448 | 11.726 |
| Comparative Example 2 | 1.790 | 4.915 | 9.433 |
| Example 1 | 2.357 | 5.794 | 11.035 |
| Example 2 | 1.831 | 4.798 | 9.015 |

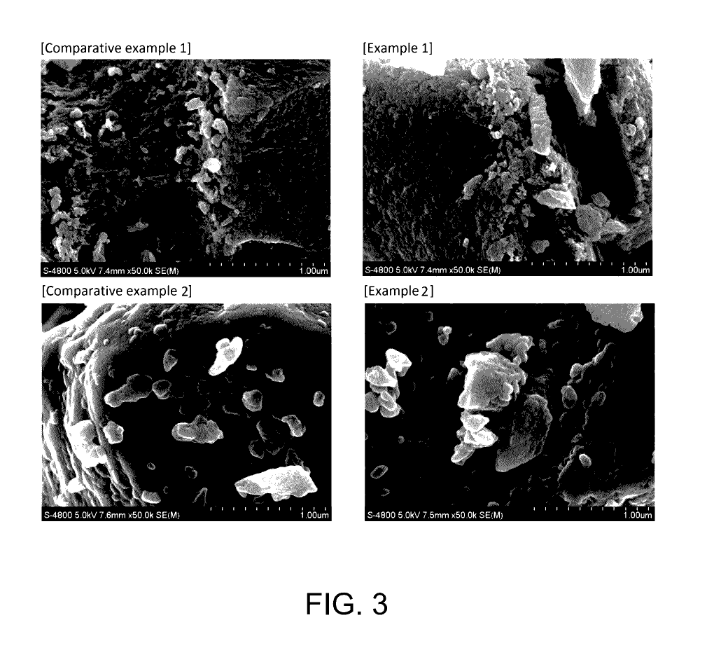

FIG. 3 shows the SEM image of the surfaces of the activated carbon according to the Examples of the present invention, and the result of component analysis of the activated carbon is described in the following Table 3.

TABLE 3

| | Comparative | | | | Example | | | |
|---|---|---|---|---|---|---|---|---|
| | Example 1 | | Comparative | | 1 | | Example 2 | |
| | | atom | Example 2 | | | atom | | atom |
| Component | wt % | % | wt % | atom % | wt % | % | wt % | % |
| C | 88.28 | 91.04 | 81.70 | 85.72 | 88.54 | 91.22 | 84.03 | 87.62 |
| O | 11.38 | 8.81 | 17.91 | 14.11 | 11.21 | 8.67 | 15.63 | 12.24 |
| Si | 0.35 | 0.15 | 0.39 | 0.17 | 0.24 | 0.11 | 0.33 | 0.15 |

Electrochemical Properties of the Activated Carbon Treated with Carbon Dioxide

After the electrodes were manufactured using the activated carbon according to the Examples of the present invention, the electrochemical properties thereof were confirmed. 85 wt % of each of the activated carbon samples manufactured in Examples 1 and 2 and Comparative Examples 1 and 2. 7 wt % of carbon black (Super-p), 3 wt % of carboxymethyl cellulose (CMC), and 5% of the styrene butadiene rubber (SBR) were mixed to manufacture an electrode material. The etched aluminum foil (2.54 cm²) was used as a current collector, and 1 M SBPBF4 was mixed with the acetonitrile solvent for use as the electrolyte. The weight of the anode was 17,446 mg (104 μm) and the weight of the cathode was 14.556 mg (94 μm) in Comparative Example 1 (a weight ratio of 1.198:1), the weight of the anode was 13,469 mg (87 μm) and the weight of the cathode was 10.396 mg (68 μm) in Example 1 (a weight ratio of 1.298:1), and the weight of the anode was 20.496 mg (126 μm) and the weight of the cathode was 15,696 mg (96 μm) in Example 2 (a weight ratio of 1.306:1).

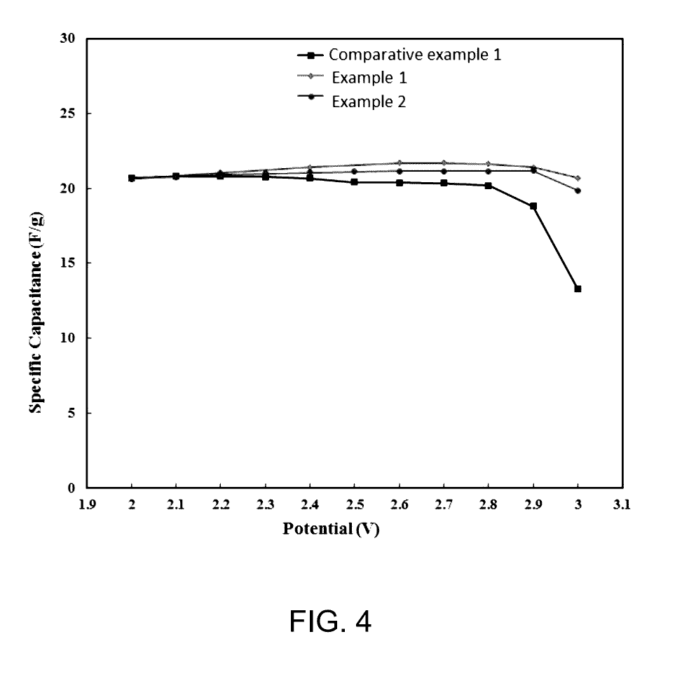

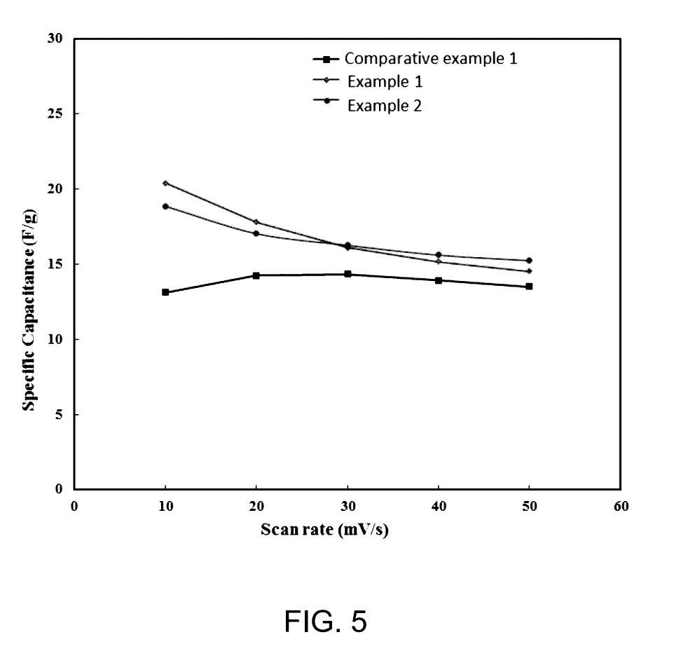

FIG. 4 shows the difference in specific capacitance depending on the voltage. From FIG. 4, it can be seen that the specific capacitance is rapidly reduced at 3 V in Comparative Example 1 but that the specific capacitance is not significantly reduced even at a high voltage of 3 V in the Examples of the present invention. FIG. 5 shows a change in specific capacitance as a function of the scan rate, and the specific capacitance is not significantly reduced even at the high scan rate in the Examples. Accordingly, the Examples may ensure a property which is suitable for embodying the high-power property of the supercapacitor.

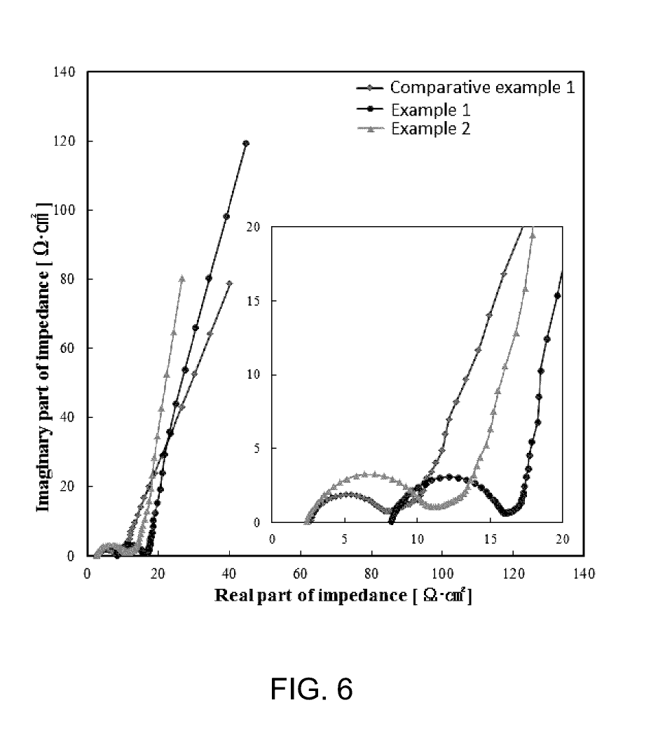

FIG. 6 shows the result of the resistance property of the present invention, and an equivalent series resistance (ESR) was 8.21 Ωcm² in Example 1, 2.39 Ωcm² in Example 2, and 8.21 Ωcm² in Comparative Example 1.

Electrolyte Composition for High Voltage

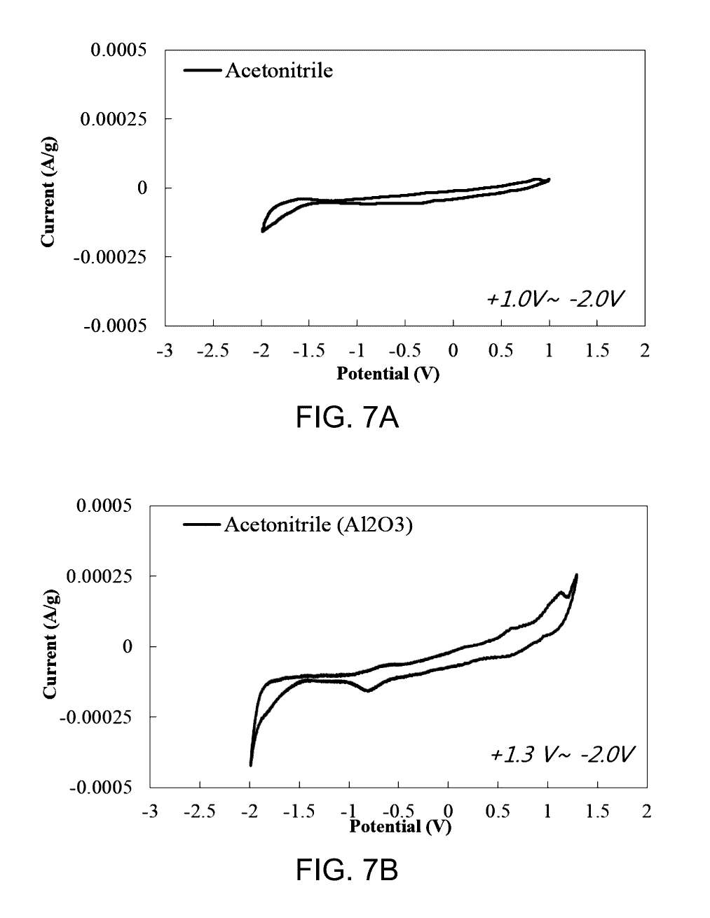

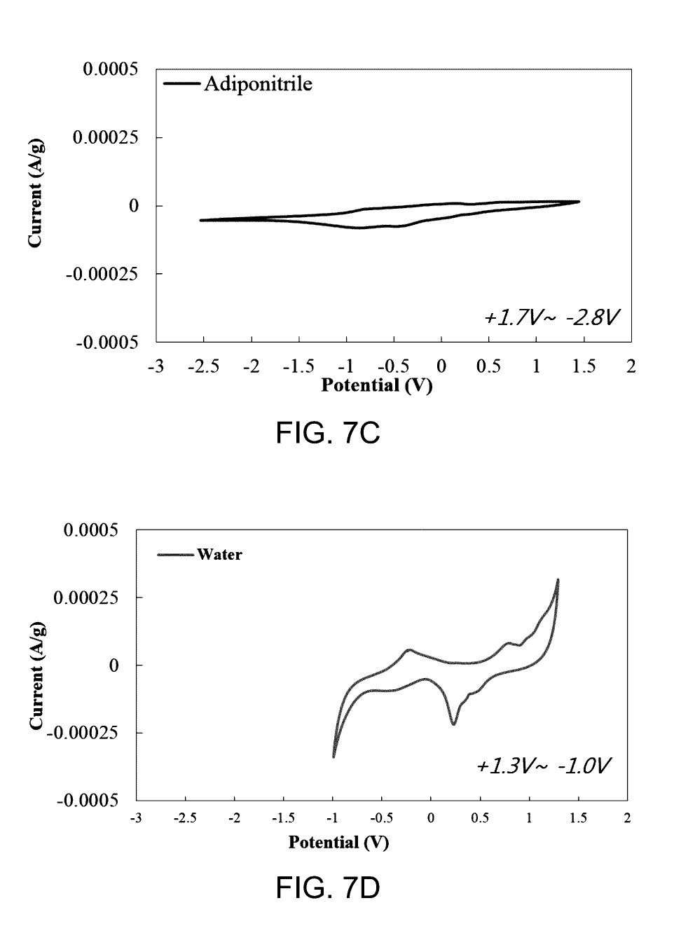

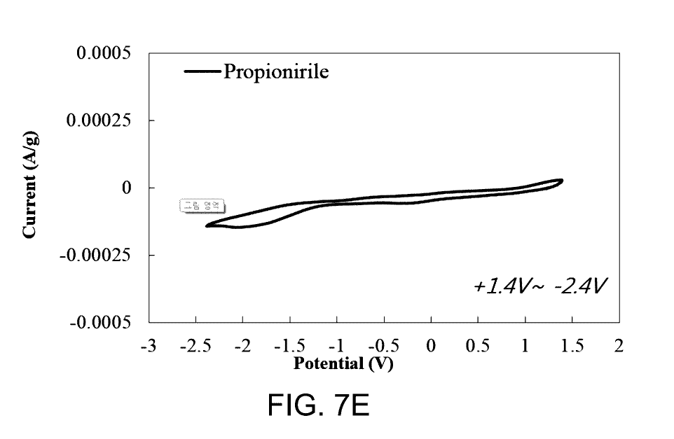

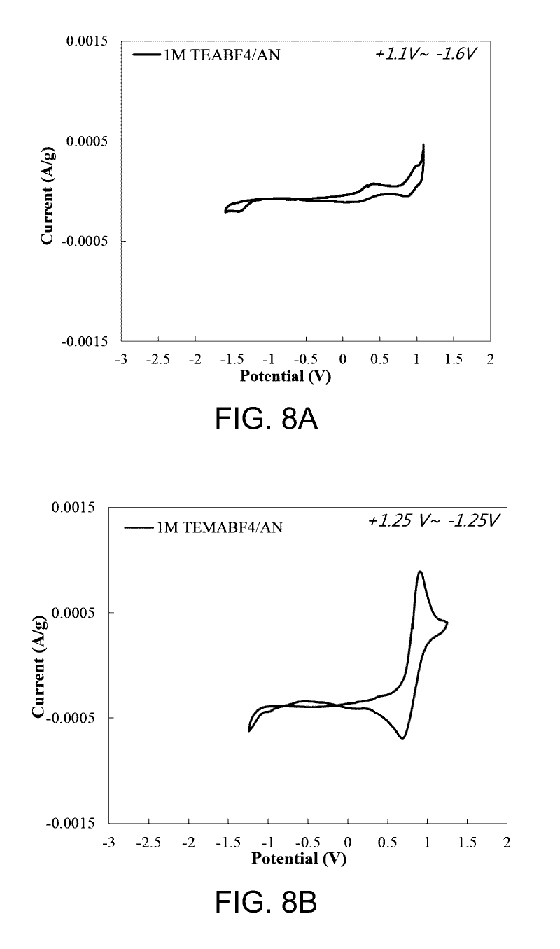

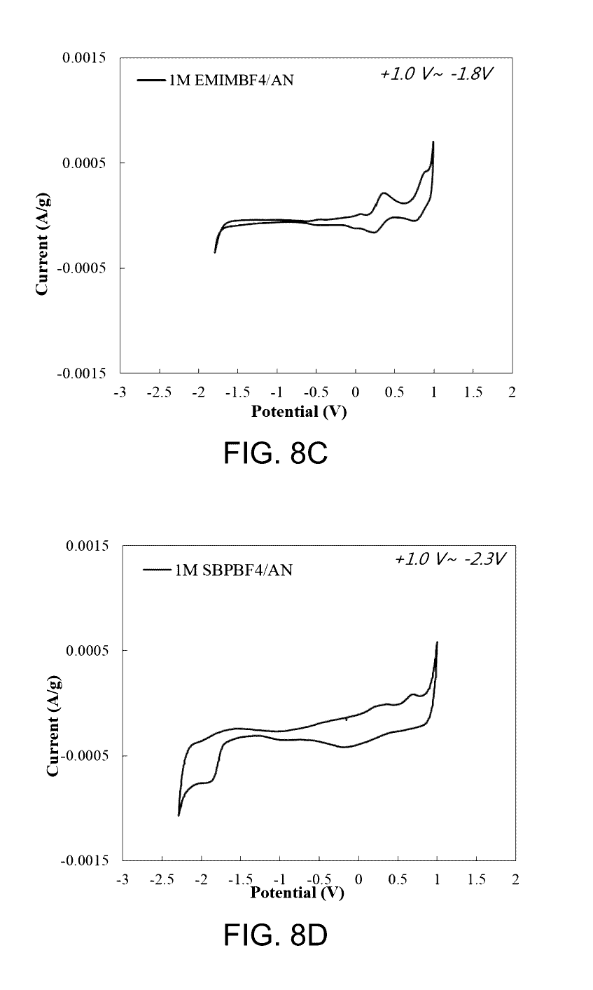

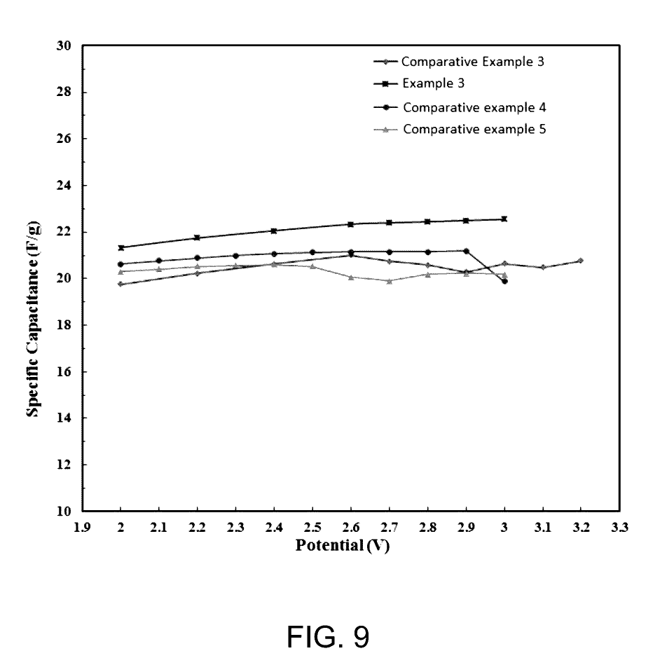

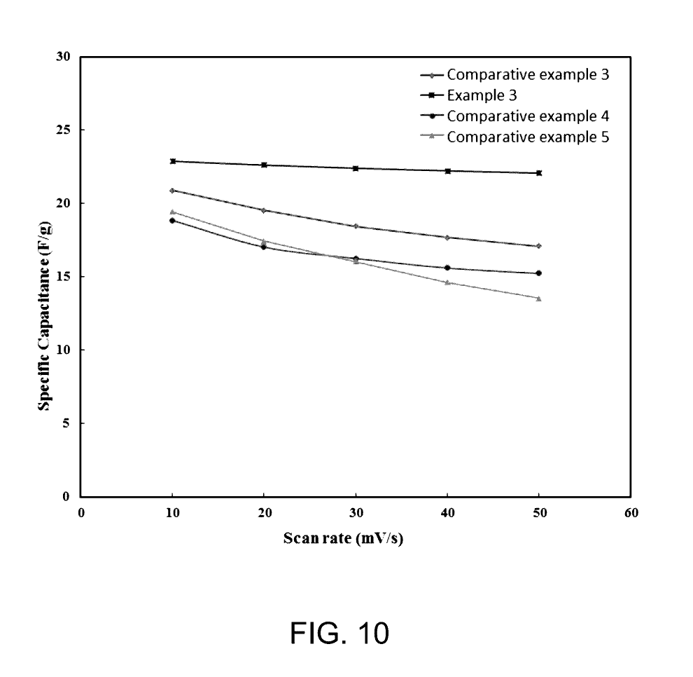

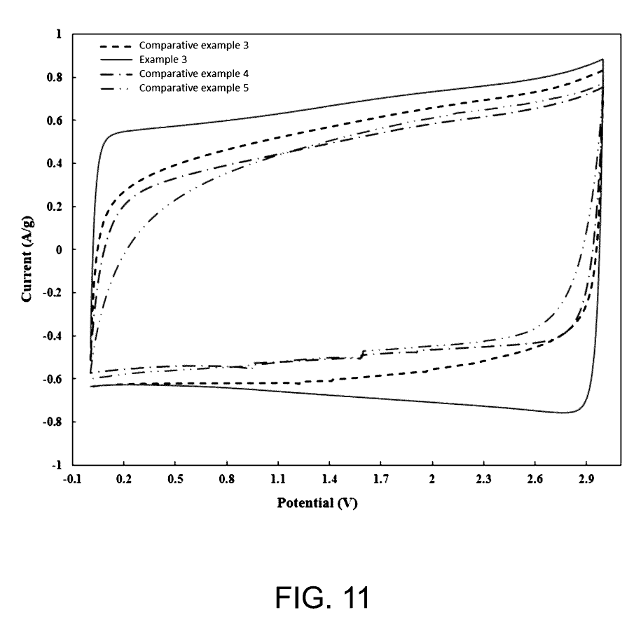

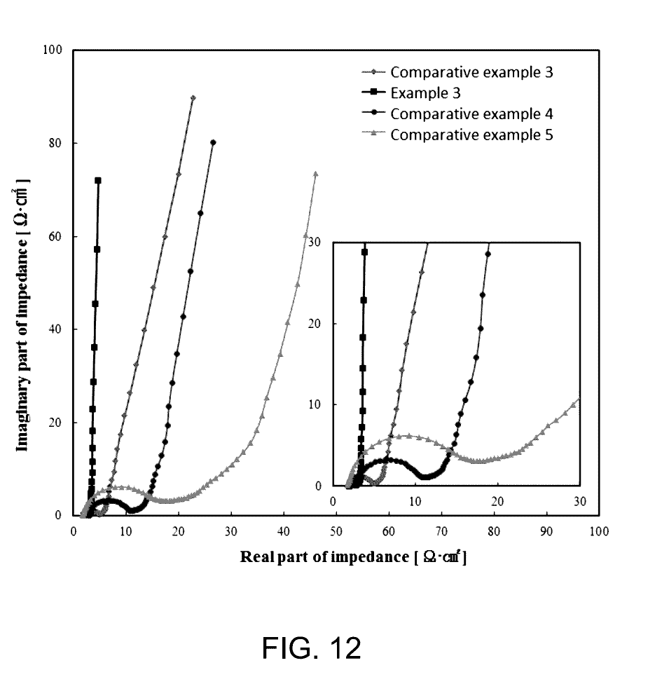

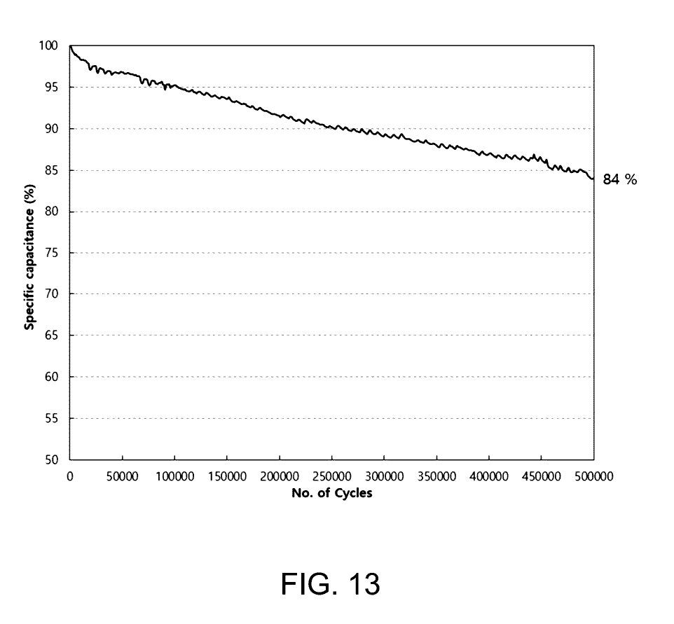

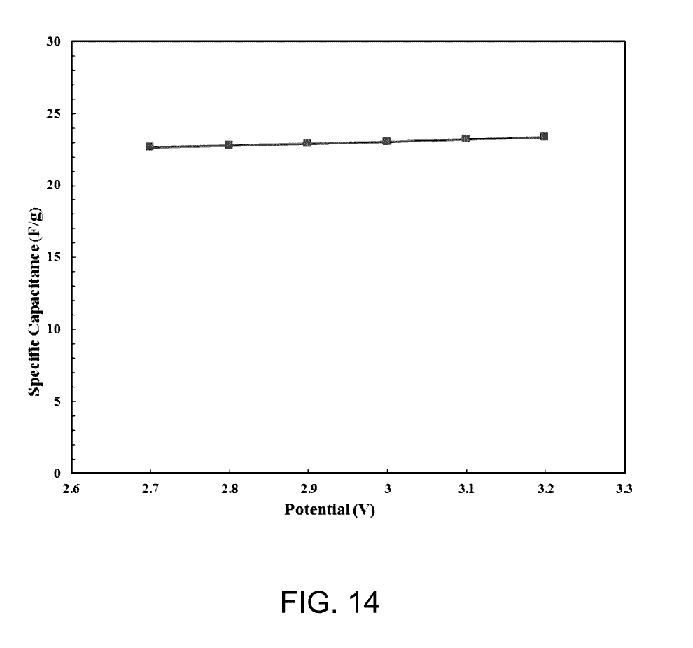

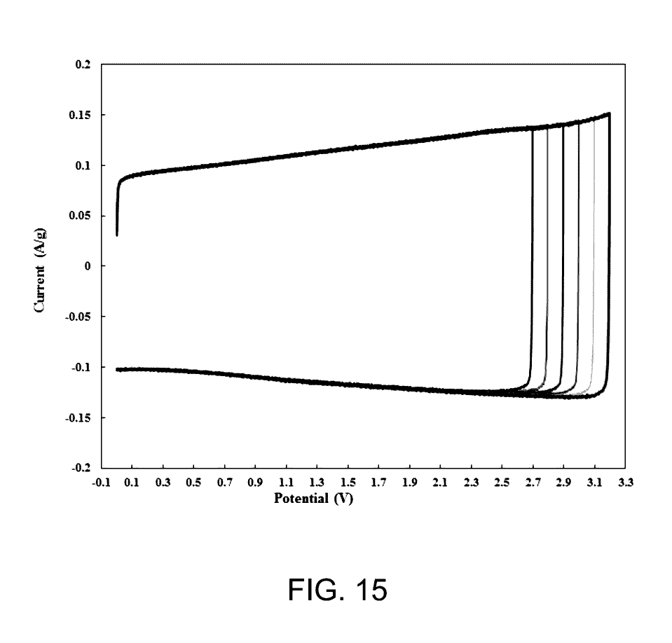

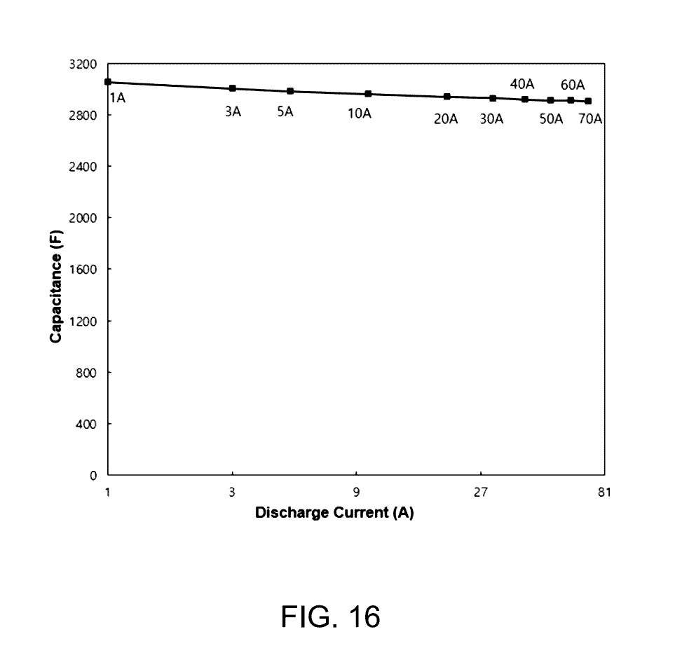

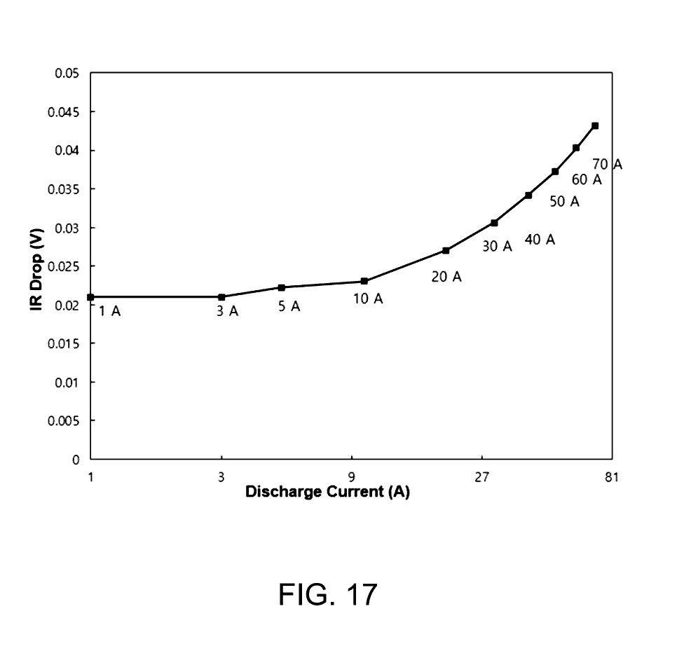

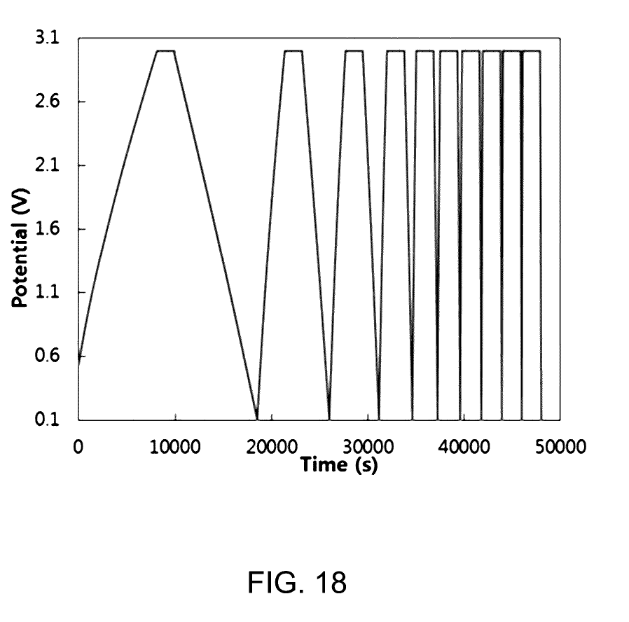

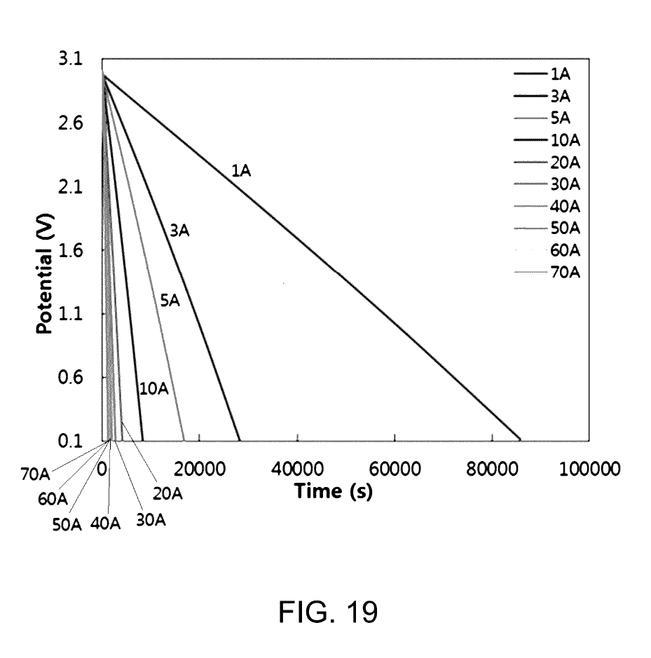

Cyclic voltammetry measurement of acetonitrile (AN), acetonitrile to which Al₂O₃ was added, adiponitrile, propionitrile, and water, which were the solvents applicable to the supercapacitor, was performed in order to select a basic solvent used to manufacture the electrolyte composition. The result of measurement is shown in FIGS. 7A to 7E. As shown in FIGS. 7A to 7E, the potential window of acetonitrile is largest. Therefore, it is expected that stable high-voltage operation is feasible when acetonitrile is used as the basic solvent of the electrolyte solution.

In order to select the optimum ion salt included in the electrolyte composition, TEABF4 (tetraethyl ammonium tetrafluoroborate), TEMABF4 (triethyl methyl ammonium tetrafluoroborate), EMIMBF4 (1-ethyl-3-methylimidazolium tetrafluoroborate), and SBPBF4 (spiro-(1,1′)-bipyrrolidium tetrafluoroborate) as the ion salt were mixed with the selected acetonitrile solvent, and the cyclic voltammetry test was then performed. The result of measurement is shown in FIGS. 8A to 8D. As shown in FIGS. 8A to 8D, the potential window is largest when SBPBF4, among the ion salts, was used.

Electrochemical Properties Depending on Weight Ratio of Electrode

The electrochemical properties, depending on the weight ratio of the electrode of the supercapacitor according to the present invention, were measured according to the following procedure. The activated carbon, which was manufactured in Example 1 of the present invention, was used as the material of the electrode to manufacture electrodes having an anode weight of 16.496 mg (104 μm) and a cathode weight of 13.496 mg (87 μm) (a weight ratio of 122:1) (Example 3), electrodes having an anode weight of 15.296 mg (95 μm) and a cathode weight of 13.296 mg (87 μm) (a weight ratio of 1.15:1) (Comparative Example 3), electrodes having an anode weight of 20.496 mg (126 μm) and a cathode weight of 15.696 mg (96 μm) (a weight ratio of 1.306:1) (Comparative Example 4), and electrodes having an anode weight of 21,396 mg (131 μm) and a cathode weight of 13.596 mg (87 μm) (a weight ratio of 1.574:1) (Comparative Example 5). The electrochemical properties were then evaluated, and the results are shown in FIGS. 9 to 15. The etched aluminum foil (2.54 cm²) was used as the current collector, and 1 M SBPBF4/AN was used as the electrolyte in each electrode. As shown in FIGS. 9 to 12, the specific capacitance and resistance and high-voltage properties were best when the electrodes according to Example 3 (the weight ratio of the anode to the cathode was 1.22:1) were applied.

In order to check the cycle life of the supercapacitors according to the Examples of the present invention and the behavior thereof at an operating voltage of 3.2 V, cycle life test, specific capacitance measurement, and cyclic voltammetry measurement were performed when electrodes having an anode weight of 24.61 mg (101 μm) and a cathode weight of 20.08 mg (90 μm) (a weight ratio of 1.22:1) were used. The etched aluminum foil (2.54 cm²) was used as the current collector, 1 M SBPBF4/AN was used as the electrolyte, and the scan rate was 5 mV/s. The results of measurement are shown in FIGS. 13 to 15.

The supercapacitor according to the present invention had a capacitance of about 90% until 300,000 cycles and a capacitance of about 84% until 500,000 cycles (FIG. 13), and the specific capacitance was not reduced even at a high voltage of 3 to 3.2 V (FIG. 14) Further, it was confirmed that a stable CV behavior was observed until 3.2 V with respect to a change in CV pattern depending on an increase in voltage (FIG. 15).

As seen from the result of the test of physical and electrochemical properties of the Examples, the supercapacitor according to the present invention had electrochemical properties such that it was stably operable even at a high voltage of 3 V due to use of the activated carbon treated with carbon dioxide, the weight ratio characteristic of the electrodes, and different compositions of the electrolytes.

Electrochemical Properties of the Supercapacitor according to the Present Invention

The electrode was manufactured using the activated carbon according to Example 1 of the present invention, and was then applied to the supercapacitor to confirm the electrochemical properties. 85 wt % of the activated carbon manufactured in Example 1 was dispersed in an aqueous solution, which included 7 wt % of carbon black (Super-p), 3 wt % of carboxymethyl cellulose (CMC), and 5% of the styrene butadiene rubber (SBR) mixed with each other and dissolved in water, to thus manufacture an electrode slurry material.

Subsequently, the electrode slurry material was applied on a slot-die coater to form a coating layer on a current collector, which included an etched aluminum foil, and the resulting layer was dried and then pressed using a roll press. The weight ratio of the anode to the cathode was maintained at 1.22:1 while the electrode slurry coating layer was formed using the slot die process, and electrodes were manufactured so that the anode was about 80 μm thick and the cathode was about 60 μm thick.

A separator was interposed between the manufactured anode and cathode and then wound, a wound element was pressed, and an insulating tube was shrunk using heat. Subsequently, after the wound element was inserted into a cylindrical exterior case, the top plate and the exterior case were welded using a laser, the opened upper end of the exterior case was curled, beading was performed so that a portion of the upper portion of the exterior case was inwardly dented, and the electrolyte solution of 1 M SBPBF4/AN was injected through the electrolyte inlet. An exterior sleeve was wrapped to manufacture a large-capacity supercapacitor cell (Example 4).

The electrochemical properties of the supercapacitor cell, which was manufactured in Example 4, were evaluated, and the results are shown in FIGS. 16 to 19.

When the charging and discharging potential window of the supercapacitor according to Example 4 is 0.1 to 3.0 V, the discharge capacitance was maintained close to 3000 F even when the discharge current was increased to 70 A (FIG. 16). When the potential window was 0.1 to 3.2 V, the IR drop was increased, depending on the discharge current, after the voltage of 3 V was maintained for 30 min, but the IR drop did not exceed a maximum of 0.045 V (FIG. 17). Further, it could be confirmed that the constant-current charging and discharging graph (FIG. 18) and the discharging graph, depending on the current, (FIG. 19) of the supercapacitor according to Example 4 of the present invention exhibited charging and discharging properties suitable for a high-voltage and large-capacity supercapacitor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A high-voltage and high-power supercapacitor having a maximum operating voltage of 3.2 V, the supercapacitor comprising:
a storage case;
a cathode;
an anode disposed to face the cathode;
a separator positioned between the cathode and the anode; and
an electrolyte solution filling the storage case,
wherein the cathode and the anode include an activated carbon treated with carbon dioxide.

2. The high-voltage and high-power supercapacitor of claim 1, wherein the activated carbon, which is treated with carbon dioxide, is manufactured using a process of heating the activated carbon in a carbon dioxide atmosphere at 500 to 1200° C.

3. The high-voltage and high-power supercapacitor of claim 1, wherein the activated carbon is pulverized using a ball mill before being treated with carbon dioxide.

4. The high-voltage and high-power supercapacitor of claim 1, wherein a weight ratio of the anode to the cathode is 1.16 to 1.30.

5. The high-voltage and high-power supercapacitor of claim 4, wherein an electrolyte includes acetonitrile.

6. The high-voltage and high-power supercapacitor of claim 5, wherein the electrolyte further includes a tetrafluoroborate-based ion salt.

7. The high-voltage and high-power supercapacitor of claim 6, wherein the ion salt is spiro-(1,1′)-bipyrrolidium tetrafluoroborate (SBPBF4).

8. The high-voltage and high-power supercapacitor of claim 6, wherein the ion salt is included at a concentration of 0.1 M to 3.0 M in the electrolyte.

9. The high-voltage and high-power supercapacitor of claim 1, wherein the cathode to and the anode are manufactured using a slot die process.

10. The high-voltage and high-power supercapacitor of claim 1, wherein the storage case is cylindrical.
